(19) United States
(12) Patent Application Publication
(10) Pub. No.: US 2026/0335783 A1
(43) Pub. Date: Oct. 29, 2026

(54) VAPOR GENERATING DEVICE FOR THEMATIC ENVIRONMENTS

(71) Applicant: DISNEY ENTERPRISES, INC., Burbank, CA (US)

(72) Inventors: Daniel Mark Joseph, Windermere, FL (US); Jessica Anne Klouda, Winter Garden, FL (US); Jason William Monahan, Celebration, FL (US); Miles Maline, Orlando, FL (US)

(73) Assignee: DISNEY ENTERPRISES, INC., Burbank, CA (US)

(21) Appl. No.: 19/187,563

(22) Filed: Apr. 23, 2025

(51) Int. Cl. A63J 5/02; B06B 1/06

(52) U.S. Cl. CPC A63J 5/025; B06B 1/06; B06B 2201/77

(57) ABSTRACT

A vapor generator for producing effects is disclosed. The vapor generator may include a housing with vapor outlet and a fluid inlet in fluid communication with a fluid external to the housing, and a vibration generator positioned within the housing and in fluid communication with the fluid inlet and the vapor outlet, wherein the vapor generator induces vibration in a fluid received from a fluid received from the fluid inlet and generates a vapor output via the vapor outlet.

### BACKGROUND

For entertainment environments, such as restaurants, theaters, or amusement parks, there may be a desire to have a “thematic” experience, such as to recreate an environment from a movie or a show, or otherwise have an alternative reality for guests to experience. Generally, the more aspects that are “on-theme”, such as food, utensils, furniture, the more realistic and immersive environment can become. Even without a theme, the visual appeal of food and drink could be improved with additional visual effects. In some instances, fog generation can be used to help provide thematic content and/or visual effects. Dry ice is often used as an easy and readily available material to help generate such fog. However, the temperature of dry ice makes its use difficult to implement in many scenarios and the fog effect is usually quite short, typically only lasting a few minutes before the dry ice completely sublimates.

### BRIEF SUMMARY

In one embodiment, a vapor generator for thematic effects is disclosed. The vapor generator may include a housing with a vapor outlet and a fluid inlet in fluid communication with a fluid source external to the housing, and a vibration generator positioned within the housing and in fluid communication with the fluid inlet and the vapor outlet, wherein the vapor generator induces vibration in a fluid received from the fluid inlet and generates a vapor output via the vapor outlet.

Optionally, in some embodiments, the vapor generator may further include a dry compartment defined by an inner wall of the housing, and a wet compartment defined by the inner wall of the housing, and wherein the wet compartment defines a flow path from the fluid inlet to the vapor outlet.

Optionally, in some embodiments, the vapor generator may further include an empty volume positioned within the dry compartment and adjacent to the vapor outlet, wherein the housing floats in the fluid source, and wherein the empty volume provides a buoyancy so that the vapor outlet and remains above a surface of the fluid source.

Optionally, in some embodiments, the vapor generator may further include a membrane in fluid communication with the vibration generator and the fluid inlet, wherein the vibration generator selectively produces the vapor output from water selectively flowed through the membrane.

Optionally, in some embodiments, the vapor generator may further include an electrical switch, and a fluid detection sensor, wherein the electrical switch turns on if the fluid detection sensor detects a fluid.

Optionally, in some embodiments, the vapor generator may further include at least one light source in electronic communication with an electrical power source, wherein the at least one light source emits light for an additional effect.

Optionally, in some embodiments, the at least one light source is a light emitting diode (LED).

Optionally, in some embodiments, the vapor generator may further include a controller in electronic communication with the at least one light source and the electrical power source, wherein the controller sends an electronic signal to the at least one light source to generate a second additional effect.

Optionally, in some embodiments, the controller is in wireless communication with at least one of a phone, or a computer that sends a wireless signal to the controller to send the electronic signal.

Optionally, in some embodiments, the vapor generator operates in a container with a maximum fluid capacity of 12 ounces or less.

Optionally, in some embodiments, the vapor generator may further include a baffle coupled to the vapor outlet, wherein the baffle defines a shape of the vapor output.

Optionally, in some embodiments, the housing comprises an upper portion and a lower portion, wherein the upper portion couples to the lower portion to define an inner wall defining a wet compartment and a dry compartment.

Optionally, in some embodiments, the vapor generator may include a rechargeable electrical power source.

Optionally, in some embodiments, the vibration generator includes a piezo electric ultrasonic transducer.

Optionally, in some embodiments, the vapor generator may further include a weight member positioned within the housing and positioned opposite to the vapor outlet, wherein the vapor outlet faces upwards when the housing is positioned in a fluid source.

In one embodiment, a method for producing a vapor output from a vapor generator is disclosed. The method may include contacting the vapor generator to a fluid source, contacting at least a portion of the fluid source to a wicking material, moving the portion of the fluid source through the wicking material to contact a vibration generator, and generating a vapor output from the portion of the fluid source by using the vibration generator.

Optionally, in some embodiments, the vibration generator produces a water vapor output from the portion of the fluid source.

Optionally, in some embodiments, at least a portion of the vapor generator floats above a surface of the fluid source.

Optionally, in some embodiments, the method may further include directing light emitted by a light source positioned within the vapor generator into the vapor output.

Optionally, in some embodiments, the method may further include operating the light source with a controller, wherein the controller selects and executes from at least one program stored in a memory device, operating the light source according to the at least one program.

### BRIEF DESCRIPTION OF THE DRAWINGS

FIG. 1 shows an example of a vapor generator in a fluid container.

FIG. 2 shows a schematic of the vapor generator of FIG. 1.

FIG. 3 is an isometric view of an example of the vapor generator of FIG. 1.

FIG. 4 is a cross-section view of the example vapor generator taken along line 4-4 in FIG. 3.

FIG. 5 is a bottom plan view of the example vapor generator of FIG. 3.

FIG. 6 is a flow chart for a method to create a thematic effect utilizing the vapor generator.

FIG. 7 is a partially transparent isometric view of another example of a vapor generator used with a food consumable.

### DETAILED DESCRIPTION

Consumables, such as beverages and food or edible items, are a staple of theme parks, cruise ships, restaurants, lounges, and resorts. Visual effects and/or themes may be added to consumables to improve their appeal. Current techniques for creating such consumables typically rely on dyed and shaped items and/or illuminated items. However, such effects are typically limited and often static, which can detract from the immersive and realistic experience of the consumable. The present disclosure includes a vapor generator that can be positioned within consumables to generate a fog or smoke effect. The vapor generator includes a housing, which may float, having a vibration generator in fluid communication with a fluid source. The vibration generator transforms the fluid (often a water portion of the fluid) into vapor by ultrasonically vibrating the fluid. The vapor is then emitted from a top end of the vapor generator while it optionally floats or is otherwise positioned in the consumable. The effect, such as in a beverage, can be of a fog or mist generating ice cube or other floatable item, and creates a long-lasting effect. Other effects, such as those generated by dry ice, are transient and often do not last for more than a few minutes, whereas the vapor generator is able to generate a continuous vapor for a sustained amount of time.

For example, the vapor generator may fit inside a beverage glass, and provide theatrics of themed beverages. For example, the vapor generator may provide a fog effect flowing out of a container (e.g., a themed beverage container). The vapor generator may be scaled to fit within various containers. For example, an embodiment of the vapor generator may fit within a container with a fluid volume of 12 ounces, or less, with the fluid volume referring to the maximum volume of fluid the container can hold. In other examples, the size of the vapor generator may be scaled to be used in large fluid bodies, such as lakes, ponds, lagoons, etc., to provide an effect. For example, the vapor generator may float in a fluid body, such as a lake or pond, and produce an emulated fog covering the lake or generate fog at certain locations or times on the fluid body.

In another example, the vapor generator may be positioned in a non-fluid environment, such as within a food or edible consumable to provide an artistic effect. In these examples, the vapor generator may be configured to be in fluid communication with a fluid source (e.g., be positioned within a tray or other fluid holding element) and the entire assembly can be positioned and optionally obscured within the food or edible consumable, e.g., to provide theatrical effects, such as to emulate smoke coming out of the volcano themed cake. The vapor generator may also be used with other food consumables, such as fruit. For example, the vapor generator may produce smoke coming out of a jack-o-lantern pumpkin. The vapor generator may be positioned in a number of different environments to create a realistic and long-lasting fog or smoke effect.

In various embodiments, the vapor generator is a wholly contained system enclosed within a housing. The housing may be compact to allow use in multiple environments and to be positioned within smaller fluid containers, such as cups, glasses, mugs, highball glasses, or other beverage holders. Despite the small volume/enclosure of the housing, all of the components are contained, including a power source (e.g., battery) and a vibration generator. This provides a small compact system and versatility in many different environments. For example, a vapor generator may take the shape of a cube with edges less than two inches in each dimension, and include an internal battery to supply power.

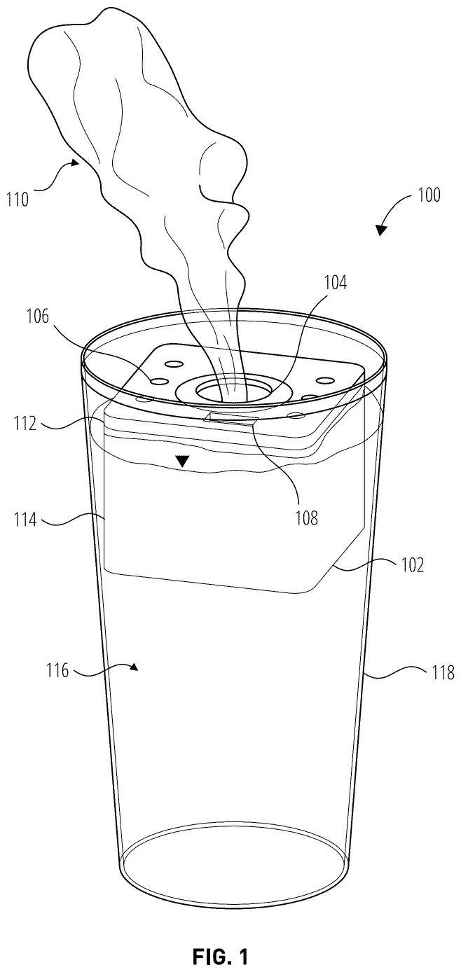

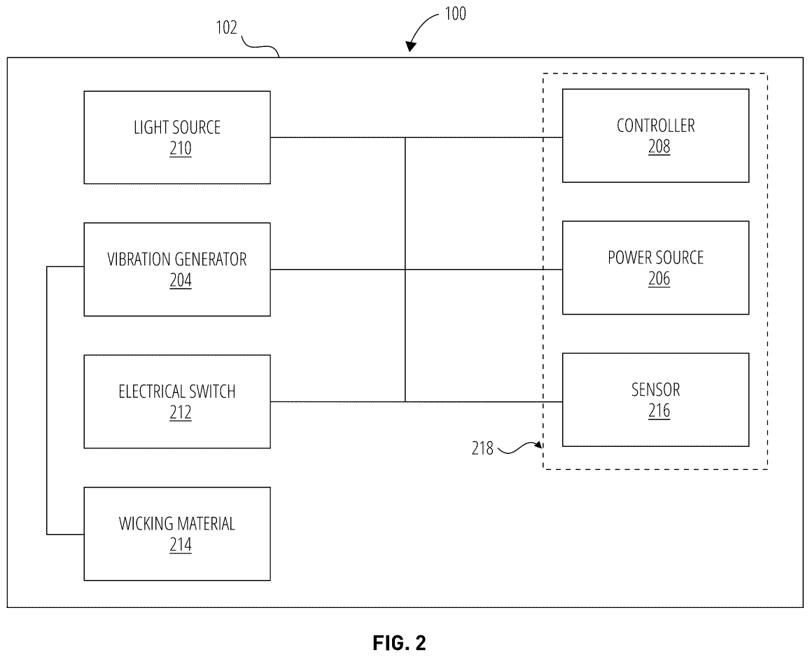

Turning to the figures, FIG. 1-3 illustrate an example of a vapor generator 100. The vapor output 110 generates a fog or smoke effect (e.g., a vapor output 110) and does not require certain temperatures, handling constraints, or other requirements of dry ice or similar fog/smoke generating elements. In FIG. 1, the vapor generator 100 is positioned and floating within a fluid source 116 held in a container 118. The vapor generator 100 may include a housing 102, a vapor outlet 104, a light aperture 106, and a charging aperture 108. Further, as shown in FIG. 2, the vapor generator 100 may also include a vibration generator 204, a wicking material 214, at least one of a light source 210, a controller 208, an electrical power source 206, and an electrical switch 212. In some embodiments, the vapor generator also includes a sensor 216.

The fluid source 116 and container 118 may vary based on the desired artistic theme or effect, e.g., the container 118 may be a beverage glass, bowl, or the like. The container 118 may define a cavity or surface to hold the fluid source 116. For example, the container 118 may include a cup, glass, mug, highball glass, vase, bowl, etc. In some embodiments, the container 118 may include/be defined by the land surrounding fluid bodies of water, such lakes, ponds, lagoons, etc. In some embodiments, the container 118 may include consumables, such as baked goods (e.g., cakes, cupcakes, pastries or combinations thereof). For example, the vapor generator 100 may be positioned in a cake shaped to appear as a volcano. In some embodiments, the container 118 may include fruits such as pumpkins, gourds, melons, pineapples, grapefruits, etc. For example, a pineapple may be cut in half and hollowed out so that the exterior surface of the pineapple forms a basin. In further embodiments, the container 118 may include any other type of food or edible consumable.

The fluid source 116 is any type of fluid or flowable element, but in most cases will include some portion of liquid. The liquid may be, for example, water. The fluid source 116 may be configured to be safe for human consumption (e.g., water, alcoholic beverages, sodas, juices, etc.) or may be configured solely as the vapor supply and may not be consumed-the consumption depends on the environment for the vapor generator (e.g., pool or lake vs. beverage).

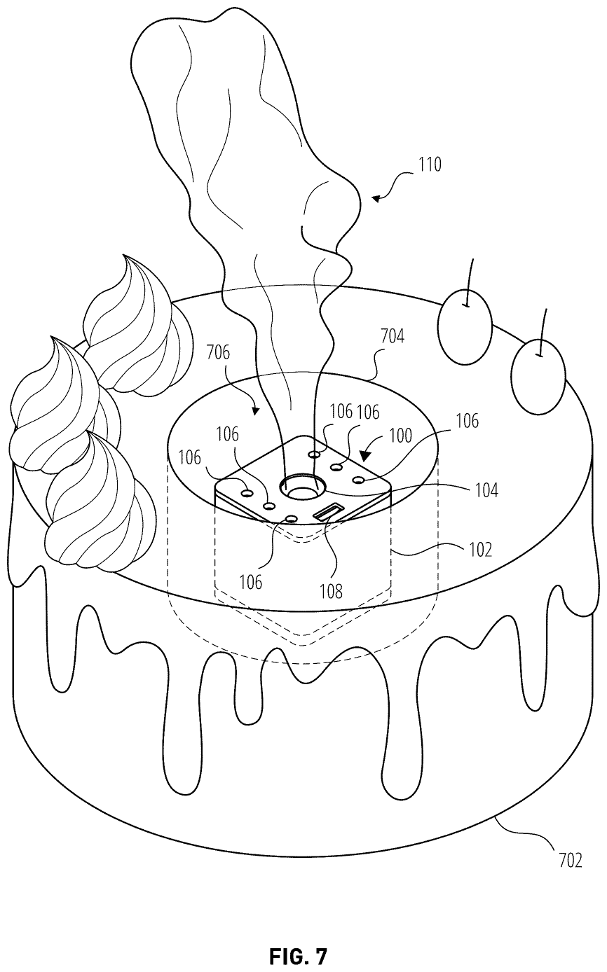

The vapor generator 100 may be configured to float on top of the fluid source 116 or may be otherwise positioned to be in fluid communication with the fluid source 116. Relatedly, the container is configured in some instances to be a beverage container, but may otherwise be configured, such as a food or edible element (see, e.g., FIG. 7) or a non-edible element.

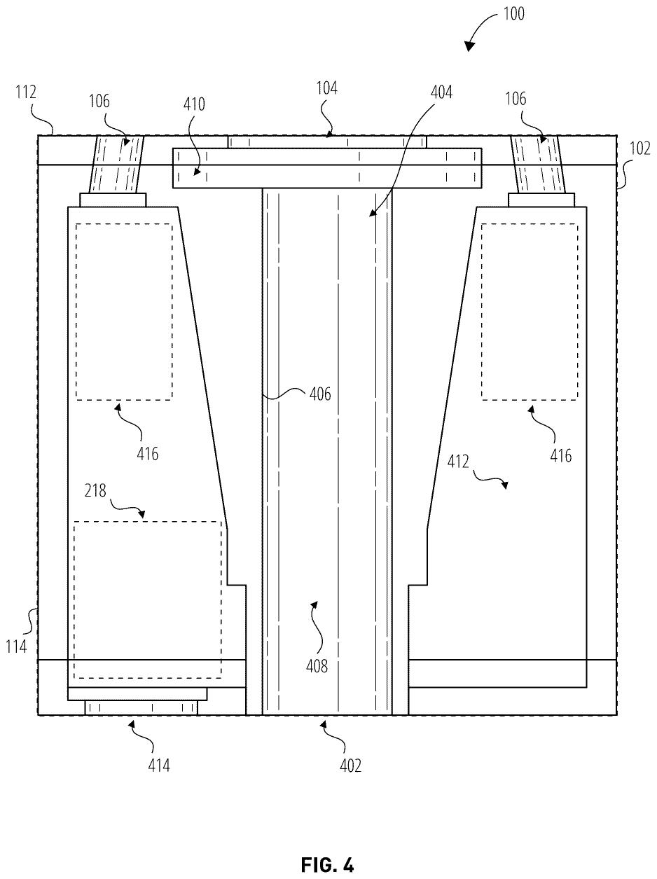

The vapor generator 100 includes a housing 102 that houses the various components to generate the vapor, as well as can be shaped based on the desired artistic aesthetics. The housing may be configured to wholly contain the system, e.g., to provide a “self-contained” vapor generation system. For example, as shown in FIG. 1, the housing 102 is shaped as a cube to be representative of an ice cube, but many other housing configurations are envisioned. For example, the shape of the housing 102 of the vapor generator 100 may include spheres, truncated spheres, rectangular prisms, cylinders, etc. The housing 102 defines one or more outer walls and may define one or more interior compartments or cavities, e.g., a component cavity and/or an empty cavity. The housing 102 may include an upper portion 112 and a lower portion 114, where the upper portion 112 may be configured to be elevated within a fluid source, e.g., include an empty volume 416 or buoyant cavities (shown in FIG. 4), and the lower portion 114 may be configured to seat within the fluid. The number and configuration of the various housing cavities depends on the housing material, fluid source, artistic desires, and the like and any specific example should be understood as exemplary only. For example, FIG. 4 shows one configuration of the housing 102 defining a wet compartment 404, a dry compartment 412, an inner cavity 410, and the empty volume 416. Other configurations are also contemplated. The housing 102 will be discussed in more detail below.

The vapor generator 100 may include the vibration generator 204. The vibration generator 204 is in fluid communication with the fluid source 116 and the vapor outlet 104, e.g., via one or more fluid paths through the housing 102. The vibration generator 204 generates the vapor output 110 by producing ultrasonic vibrations from fluid in contact with the vibration generator 204 (e.g., fluid source 116). In some embodiments, the vibration generator 204 may include a piezoelectric transducer that vibrates selectively based on an electrical signal.

The vapor generator 100 may include the wicking material 214. The wicking material 214 is in fluid communication with the fluid source 116 and the vibration generator 204. The wicking material 214 facilitates the movement of the fluid source 116 to the vibration generator 204. In some embodiments, the wicking material 214 may include a plurality of tubes made out of synthetic fibers and may function as, or include, a membrane. The wicking material 214 and/or membrane may be configured to allow only a desired fluid (e.g., water) to permeate therethrough to ensure that the vibration generator can properly generate the vapor and help prevent debris or the like from clogging the vapor generator.

The vapor generator 100 may include one or more of the light source(s) 210. The light source 210 is in electrical communication with a controller 208 and the electrical power source 206 and configured to emit light, such as to enhance the artistic effect. In one example, there may be multiple light sources 210 and they may be positioned to illuminate an interior or exterior of the housing 102 and/or illuminate the vapor output 110 as it is emitted from the vapor generator 100. For example, the light sources may be positioned so as to emit light onto the vapor output 110 as it exits the vapor outlet 104. The light sources may be any type of illuminating element, but in many instances will include one or more light emitting diodes (LEDs) or organic light emitting diodes (OLEDs) and can be configured to emit in a variety of different hues or patterns.

The vapor generator 100 may include the controller 208 to control operations of the vibration generator 204 and optional light source(s) 210. The controller 208 is in electronic communication with the vibration generator 204 and the light source 210 to provide electrical signals (e.g., voltage) to the vibration generator 204 and the light source 210. At the direction of the signals sent by the controller 208, the vibration generator 204 and the light source 210 may produce different visual effects with the vapor output 110. The different visual effects may increase the visual appeal of using the vapor generator 100. The controller 208 may include a processing element or microcontroller.

The vapor generator 100 may include the electrical power source 206 that provides power to the components of the vapor generator 100. To that end, the electrical power source 206 is in electronic communication with the controller 208, the vibration generator 204, the light source 210 and other components that may require power. In some embodiments, the electrical power source 206 includes a rechargeable battery, a non-rechargeable battery, or combinations thereof. An electrical switch 212 acts to provide an input to the vapor generator 100, e.g., may complete or break the electrical circuit from the electrical power source 206, turning the vapor generator 100 on or off. In some embodiments, the electrical switch 212 may include, but is not limited to, a button, a push/pull switch, or a dial. In some embodiments, the electrical switch 212 is a wireless communication switch and/or may be activated by a sensor, e.g., fluid sensor that turns on the vapor generator when placed in a fluid. Other input/output components may be included with vapor generator as desired.

Optionally, the vapor generator 100 may include one or more sensor(s) 216, such as environmental sensors, such as a temperature or humidity sensor, or a sensor to detect the presence of liquid, e.g., a similar sensor used in leak detection. The sensor 216 may be in electronic communication with the electrical switch 212 and can activate the electrical switch 212 depending on a sensed state, e.g., whether liquid is detected.

Optionally, the vapor generator 100 may include a controller housing 218. The electrical components, such as the controller 208, the power source 206, and the sensor 216 may be positioned within the controller housing 218. A wall within the housing 102 may define the controller housing 218. In some embodiments, the controller housing 218 may be a separate body from the housing 102, e.g., a container within the housing. The controller housing 218 prevents the fluid source 116 from contacting the electrical components. In some embodiments, the controller housing 218 is configured so that the vapor outlet 104 orients upwards when the vapor generator 100 is positioned in the fluid source 116.

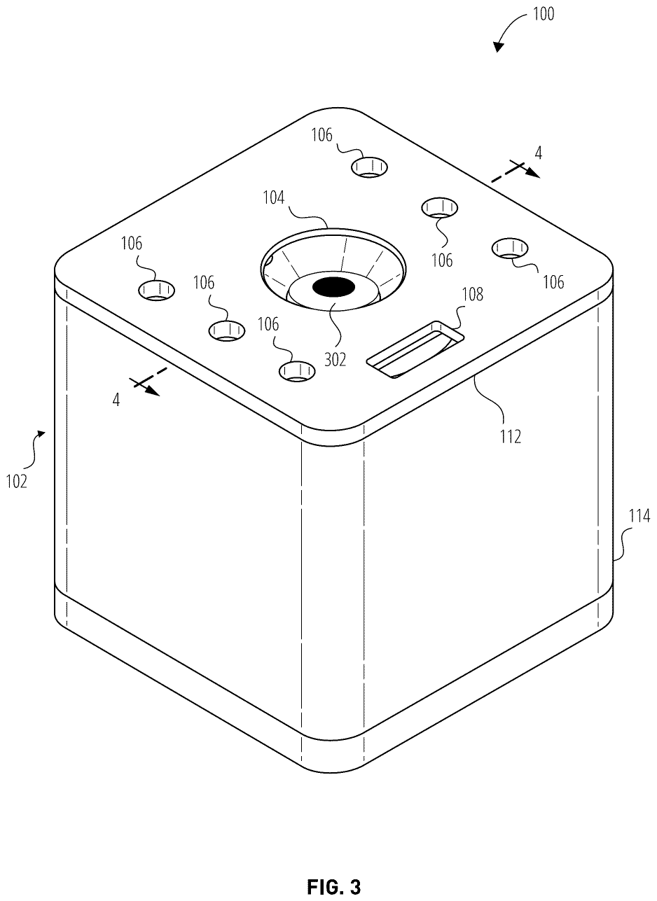

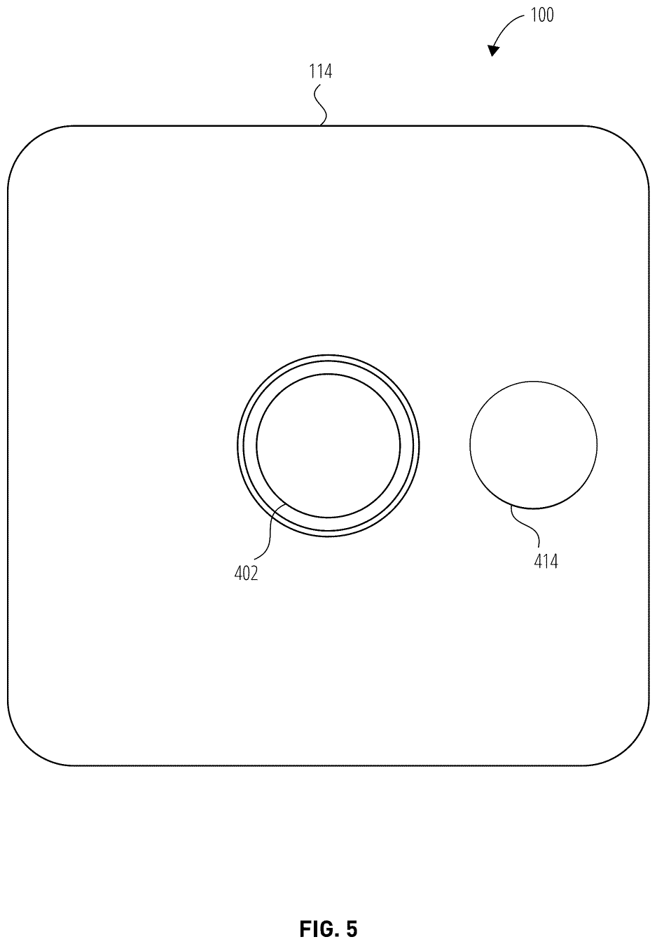

The housing 102 will now be discussed in more detail with reference to FIGS. 3-5. As noted above, the housing 102 forms a compartment for the various components of the vapor generator and acts to position them within an environment, such as floating in a fluid or the like. The housing 102 is in fluid communication with the fluid source and includes both an inlet and an outlet. The housing 102 may be constructed out of various materials, such as, but not limited to, polymers, acrylic, food grade plastic, or combinations thereof. In some embodiments, the housing 102 may float in the fluid source 116, and may include low density materials, such as acrylic, low density polymers, etc.

As shown for example in FIG. 1 and FIG. 3, the vapor outlet 104 is defined by the housing 102. In some embodiments, the vapor outlet 104 is positioned centrally on a top surface of the housing 102 or otherwise in a desired “output” direction for the vapor (e.g., in some creative applications may be configured as a side surface of bottom surface of the housing 102 and/or may be closer to a side edge or perimeter or otherwise offset from a center of the surface). In instances where the vapor generator 100 is configured to float, the vapor outlet 104 is positioned on a portion of the housing 102 that is not submerged within the fluid to ensure that the fluid does not inadvertently block the emission of the vapor from the vapor outlet 104.

Optionally, the vapor generator 100 may include a vapor shaping element, such as a baffle, along the fluid path. In addition, the vapor output 110 may behave differently due to the baffle. For example, without a baffle, the vapor output 110 may eject out of the vapor generator 100 in an upwards trajectory as a jet. With a baffle, the vapor output 110 may waft out of the vapor generator 100 to form a stratiform, like a low lying fog. Other shapes and behaviors of the vapor output 110 produced by the baffle are also contemplated and the baffle can be construed based a desired shape or effect. As shown for example in FIG. 3, the baffle 302 is positioned adjacent the vapor outlet 104 and configured to shape or generate discontinuities in the vapor to enhance the artistic effect. In some embodiments, instead of the baffle 302, the housing 102 may define the vapor outlet 104 to shape the vapor output 110. For example, the housing 102 may define the vapor outlet 104 as a rectangular slit so the vapor output 110 fans out as it flows out of the vapor generator 100.

The housing 102 may include an upper portion 112 coupled to a lower portion 114. When coupled together, the upper portion 112 and the lower portion 114 may define an inner surface of the housing 102. In some embodiments, the lower portion 114 defines a portion of the housing 102, and defines the inner wall shaping the wet compartment 404, the dry compartment 412, the lumen 408, and at least a portion of the inner cavity 410. In some embodiments, at least a portion of the lower portion 114 seats in the fluid source 116 when the vapor generator 100 is positioned in the fluid source 116. In some embodiments, the housing 102 may be a unitary body. In some embodiments, the portions may couple using adhesive, snap and fit features, fasteners, or combinations thereof. In some embodiments, the housing 102 may be produced using injection moldings techniques and/or three-dimensional printing, or other manufacturing techniques depending on the housing materials and configuration.

The housing 102 may define the inlet 402. In some examples, the inlet 402 may be positioned on a bottom surface or submerged portion of the housing 102. The inlet 402 may be positioned on the bottom surface of the vapor generator 100 to conceal the inlet 402 from view and/or limit the amount of fluid source 116 required to fill the container 118 (e.g., just needs to cover or reach the bottom). In some embodiments, the location of the inlet 402 may vary based on creative desires. The fluid source 116 may enter the vapor generator 100 by flowing through the inlet 402.

Optionally, the vapor generator 100 may include a filter, either in front or after, the inlet 402 to help prevent particles from entering the housing or blocking fluid flow.

As shown for example in FIG. 4, the housing 102 defines an internal compartment or compartments to receive various components of the vapor generator 100. The housing 102 may include various walls or other elements to define “sealed” compartments to protect certain components from fluid exposure, while also including the inlet 402 for enabling fluid communication from the environment (e.g., fluid source 116) into the housing 102.

The inlet 402 allows the fluid source 116 external to the housing 102 to enter a wet compartment 404, defined by an inner wall 406 of the housing 102. The wet compartment 404 defines a flow path allowing at least a portion of the fluid source 116 to flow from the inlet 402 to the vapor outlet 104, e.g., through an inner cavity 410. At least a portion of the inner wall 406 may define a lumen 408 extending from the inlet 402 to the inner cavity 410. The inner cavity 410 is adjacent to and in fluid communication with the vapor outlet 104. The wet compartment 404 may house the wicking material 214 within the lumen 408 and houses at least a portion of the vibration generator 204 within the inner cavity 410. In some embodiments, the inner cavity 410 may be defined to the shape of the vibration generator 204. For example, the vibration generator 204 may be shaped as a puck like cylinder and the inner cavity 410 may take the shape of a puck like cylinder.

Optionally, a seal member may seat around the vibration generator 204 to prevent fluid flow around vibration generator 204. For example, the seal member may compress against an inner surface of the inner cavity 410 and against an exterior surface of the vibration generator 204 adjacent to the inner surface of the inner cavity 410 to form a liquid tight connection and to ensure all fluid flows into the vibration generator 204.

Optionally, the housing 102 may define an internal reservoir or chamber to contain the fluid source 116. For example, the internal reservoir may contain the fluid source 116 so the vapor generator 100 does not need to float in a fluid source 116 to operate. The reservoir may be in fluid communication with the vibration generator 204 through the wicking material 214. The fluid source 116 may flow from the reservoir through the wicking material 214 to contact the vibration generator 204 positioned in the inner cavity 410. The housing 102 may define an aperture to allow the fluid source 116 to flow into the housing 102 to fill the reservoir. The vapor generator 100 may include a removable portion to seal the aperture and allow the reservoir to be refilled. In some embodiments, the housing 102 may include both the wet compartment 404 and the internal reservoir. For example, the vapor generator 100 may be manufactured to work in environments that require the fluid source 116 to be external and internal to the housing 102.

The housing 102 may also define the dry compartment 412 housing electrical components, including the electrical power source 206, the controller 208, at least a portion of the vibration generator 204 and at least a portion of the electrical switch 212. The dry compartment 412 may prevent electrical components from shorting or otherwise becoming damaged due to contact with the fluid source 116. The inner wall 406 separates the dry compartment 412 from the wet compartment 404 and prevents fluid communication between the two. The dry compartment 412 also includes the empty volume 416. In some embodiments, the housing 102 may separate the dry compartment 412 from the empty volume 416 with a wall. In some embodiments, one or more of the empty volume 416 is positioned adjacent to the vapor outlet 104 so that the vapor outlet 104 remains above the surface of the fluid source 116 and the vapor outlet 104 orients upwards when the housing 102 is floating in the fluid source 116. In some embodiments, the floating generator 100 is configured so that the empty volume 416 creates a particular orientation when the vapor generator 100 is positioned in the fluid source 116. For example, the empty volume 416 may be positioned in an upper half of the housing 102, and when placed in the fluid source 116, the vapor generator 100 will float with the vapor outlet 104 oriented away from the surface of the fluid source 116. In some embodiments, a portion of the dry compartment 412 is the empty volume 416. In some embodiments, the electrical components are configured to seat within the dry compartment and opposite to the vapor outlet 104 so that the vapor outlet 104 orients upwards when the vapor generator 100 is positioned in the fluid source 116. It should be noted that the specific configuration of walls and compartments may be readily varied based on the selected components, housing size, etc. and the discussion of any particular configuration is meant as illustrative.

Optionally, the vapor generator 100 may include a weight member or other positioning member within the housing 102. The weight member is configured to help orient the housing so that the vapor outlet is positioned as desired. In one example, the weight is positioned opposite to the vapor outlet 104 and enables the vapor outlet 104 to be oriented upwards due to the effect of the weight member in orienting the vapor generator 100 when floating in the fluid source 116. In some embodiments, at least a portion of the vapor generator 100 does not submerge below a surface of the fluid source 116, even with the weight member within the housing 102 to ensure that the vapor is not “blocked” by fluid traveling over the vapor outlet 104.

The housing 102 may define one or more light apertures 106. As shown for example in FIG. 3, the housing 102 may define one or more of the light apertures 106 positioned on the top surface adjacent to the vapor outlet 104. Light may be directed into or towards the vapor output 110 by the light aperture 106. The light aperture 106 may define a light path that is angled toward the vapor outlet 104 so that light directed through the light aperture 106 will emit into the vapor output 110. In some embodiments, one or more of the light aperture 106 may be arranged concentrically around the vapor outlet 104. In some embodiments, the housing 102 may define one or none of the light aperture 106.

The light aperture 106 may extend from the outer surface of the housing 102 to the dry compartment 412. The light aperture 106 may be sealed to prevent fluid source 116 from entering the dry compartment 412. The light aperture 106 may receive the light source 210. The exterior surface of the light source 210 may couple with the outer surface of the light aperture 106 to form a liquid tight seal when positioned within the light aperture 106. In some embodiments, a seal member may be used to form a liquid tight seal. The seal member may include sealing adhesive, O-rings, gaskets, or combinations thereof. As shown in FIG. 4, the light aperture 106 may define an angle pointing towards the vapor outlet 104. The angle directs light from the light source 210 into the vapor output 110.

The housing 102 may define a charging port or charging aperture 108 on the top surface of the vapor generator 100. The electrical power source 206 of the vapor generator 100 may recharge via an electrical connection through charging aperture 108. Electrical connections may include, but are not limited to, universal serial bus (USB) C, USB A, or USB B connections. The vapor generator 100 may include a removable portion (e.g., cover) to seal the charging aperture 108 and prevent the fluid source 116 from entering through the charging aperture 108.

The charging aperture 108 may also extend from the outer surface of the housing 102 to the dry compartment 412. The charging aperture 108 may be sealed to prevent fluid source 116 from entering the dry compartment 412. As described herein, a removable portion may seal the charging aperture 108 to prevent the fluid source 116 from entering the dry compartment 412, while also providing access to a charging adaptor when removed. A seal member may be used to form a removable liquid tight connection between the removable portion and the exterior surface of the charging aperture 108. For example, the seal member may include an O-ring, gasket, or combinations thereof.

The housing 102 may define the switch aperture 414. The switch aperture 414 may provide access to the electrical switch 212. In some embodiments, at least a portion of the electrical switch 212 may protrude from the switch aperture 414.

To assemble the vapor generator 100, the various electrical components (e.g., controller 208, power source 206, etc.) are positioned within the dry compartment 412. The vibration generator 204 is positioned so as to be in fluid communication with the inlet 402 and positioned in the flow path between the inlet 402 and vapor outlet 104. In use, the vapor generator 204 is activated, e.g., via the electrical switch 212 or through a sensor 216, and positioned in a fluid source 116. Fluid, and in many examples, water, flows through the inlet 402, into the flow path defined by wet compartment 404, and through the membrane into the vibration generator 204. The controller 208 activates the vibration generator 204 to cause it to vibrate, introducing vibration forces into the fluid (e.g., water). This causes the fluid to transition into a vapor and then flow out of the vapor outlet 104. The positioning of the housing empty volumes and/or weight member allows the vapor to exit the outlet 104 without being blocked by the fluid (if in a floating configuration). The light sources 210 and/or baffle 302 introduce additional thematic elements into the vapor, such as to introduce a hue or shape to the vapor.

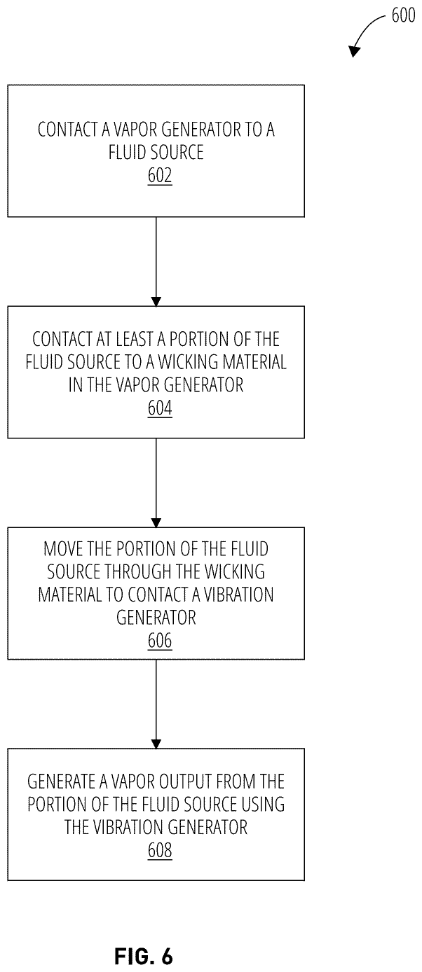

FIG. 6 illustrates an example method 600 of utilizing the vapor generator 100. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

As shown for example in FIG. 6, the method 600 may begin with operation 602 by contacting the vapor generator 100 to a fluid source 116. This includes floating the vapor generator 100 in the fluid source 116, e.g., placing the vapor generator 100 in a beverage or filling an internal reservoir with the fluid source 116.

After the vapor generator 100 contacts the fluid source 116, the method 600 may proceed to contacting at least a portion of the fluid source 116 to a wicking material 214 at operation 604. For example, the fluid source 116 may flow through an inlet 402 defined by a housing 102 to contact the wicking material 214.

Once the fluid source 116 contacts the wicking material 214, the method 600 may proceed to operation 606 and a portion of the fluid source 116 flows through the wicking material 214 to contact a vibration generator 204. Capillary action may drive the portion of the fluid source 116 to flow through the wicking material 214. In some embodiments, the wicking material 214 may include a membrane so that the wicking material 214 selectively flows a portion of the fluid source 116. For example, the membrane may selectively flow water through the wicking material 214. Producing the vapor output 110 from water may prevent hazards. For example, when used in alcoholic beverages, the vapor generator 100 may produce the vapor output 110 including ethyl alcohol. Vaporized ethyl alcohol may pose health concerns for people, such as children or people sensitive to ethyl alcohol. Vaporized ethyl alcohol may also pose a flammability risk. In the embodiments where the wicking material 214 includes the membrane, the vibration generator 204 may produce the vapor output 110 from water, even if used in an alcoholic beverage. For example, the wicking material 214 and the membrane may selectively move water from the alcoholic beverage to the vibration generator 204, while alcohol remains in the alcoholic beverage, external to the vapor generator 100. The water may come from the alcoholic beverage itself, or from a portion of an ice cube in the alcoholic beverage that has melted. The membrane may selectively flow a portion of the fluid source 116 via osmosis, pore size, hydroaffinity, or combinations thereof.

The method 600 may proceed to operation 608, which includes generating a vapor output 110 from the portion of the fluid source 116 using the vibration generator 204. The vibration generator 204 may produce ultrasonic vibrations which may form small droplets from the portion of fluid source 116. The small droplets may then vaporize into a vapor output 110 and flow through a vapor outlet 104.

In some embodiments, a light source 210 may emit light towards the vapor output 110 to produce additional theatrics with the vapor output 110. For example, the floating vapor generator 100 may direct light into the vapor output 110, which the vapor output 110 may reflect internally, creating visual effects. Visual effects may include, but are not limited to, brightening the vapor output 110 with light emitted by the light source 210 and/or the vapor output 110 taking the color of the light. In some embodiments, the controller 208 may communicate on a wireless network with a processor, such as a phone and/or a computer. The phone and/or computer may send wireless signals received by the controller 208, which then sends signals to produce desired theatrics from the vapor generator 100. In some embodiments, the floating vapor generator 100, through a wireless communication system, may coordinate visual effects with other floating vapor generators 100.

In some embodiments, a controller 208 may allow the vapor generator 100 to produce more theatrics. For example, the controller 208 may send electrical signals to the light producing element 210 to change or produce other thematic effects, such as create flashing and/or strobe effects, and/or produce different colors of light. In some embodiments, the controller 208 may also communicate electronically with the vibration generator 204 to create different flows and patterns of the vapor output 110. For example, the controller 208 may turn the vibration generator 204 on and off intermittently so the vapor output 110 flows out of the vapor outlet 104 intermittently. In some embodiments, the controller 208 selects and executes from one or more of a program stored in a memory device, and directs the light source 210 according to the program.

FIG. 7 illustrates an example of a vapor generator 100 used with a consumable 702. The vapor generator 100 may be positioned in a consumable 702 to produce a vapor output 110 for theatrical or thematic effect. As shown for example in FIG. 7, the fluid source 116 may not need to be external to the vapor generator 100 to produce the vapor output 110. Instead, the fluid source 116 is contained in an internal reservoir positioned within the vapor generator 100 as described herein.

In some embodiments, the consumable 702 may include baked goods, for example, cakes, pastries, or breads. In some embodiments, the consumable 702 may include fruits, for example, melons, gourds, squashes, pineapples, etc. As shown for example in FIG. 7, the consumable 702 may define a cavity 706 and an aperture 704. For example, a cake may be hollowed out to define the cavity 706 and the aperture 704. The vapor generator 100 may be positioned within the cavity 706 and produce the vapor output 110 to flow out of the aperture 704. In some embodiments, the consumable 702 surrounds the fluid source 116 positioned within the cavity 706. In some embodiments, the container 118 is positioned within the cavity 706 and holds the fluid source 116 external to the vapor generator 100, which the vapor generator 100 may be in fluid communication with and operate in.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A vapor generator for effects comprising:
a housing including a vapor outlet and a fluid inlet in fluid communication with a fluid source external to the housing; and
a vibration generator positioned within the housing and in fluid communication with the fluid inlet and the vapor outlet, wherein the vapor generator induces vibration in a fluid received from the fluid inlet and generates a vapor output via the vapor outlet.

2. The vapor generator of claim 1, further comprising:
a dry compartment defined by an inner wall of the housing; and
a wet compartment defined by the inner wall of the housing, and wherein the wet compartment defines a flow path from the fluid inlet to the vapor outlet.

3. The vapor generator of claim 2, further comprising an empty volume positioned within the dry compartment and adjacent to the vapor outlet, wherein the housing floats in the fluid source, and wherein the empty volume provides a buoyancy so that the vapor outlet remains above a surface of the fluid source.

4. The vapor generator of claim 1, further comprising a membrane in fluid communication with the vibration generator and the fluid inlet, wherein the vibration generator selectively produces the vapor output from water selectively flowed through the membrane.

5. The vapor generator of claim 1, further comprising:
an electrical switch; and
a fluid detection sensor, wherein the electrical switch turns on if the fluid detection sensor detects a fluid.

6. The vapor generator of claim 1, further comprising:
at least one light source; and
an electrical power source in electronic communication with the at least one light source, wherein the at least one light source emits light for an additional effect.

7. The vapor generator of claim 6, wherein the at least one light source is a light emitting diode (LED).

8. The vapor generator of claim 6, further comprising a controller in electronic communication with the at least one light source and the electrical power source, wherein the controller sends an electronic signal to the at least one light source to generate a second additional effect.

9. The vapor generator of claim 8, wherein the controller is in wireless communication with at least one of a phone, or a computer that sends a wireless signal to the controller to send the electronic signal.

10. The vapor generator of claim 1, wherein the vapor generator operates in a container with a maximum fluid capacity of 12 ounces or less.

11. The vapor generator of claim 1, further comprising a baffle coupled to the vapor outlet, wherein the baffle defines a shape of the vapor output.

12. The vapor generator of claim 1, wherein the housing comprises an upper portion and a lower portion, wherein the upper portion couples to the lower portion to define an inner wall defining a wet compartment and a dry compartment.

13. The vapor generator of claim 1, further comprising a rechargeable electrical power source.

14. The vapor generator of claim 1, wherein the vibration generator comprises a piezo electric ultrasonic transducer.

15. The vapor generator of claim 1, further comprising a weight member positioned within the housing and positioned opposite to the vapor outlet, wherein the vapor outlet faces upwards when the housing is positioned in a fluid source.

16. The vapor generator of claim 1, further comprising a battery positioned within the housing in electrical communication with the vibration generator, wherein the housing defines a cube with an exterior edge less than two inches long in each dimension.

17. A method for producing a vapor output from a vapor generator, the method comprising:
contacting the vapor generator to a fluid source;
contacting the fluid source to a wicking material;
moving a portion of the fluid source through the wicking material to contact a vibration generator;
generating a vapor output from the portion of the fluid source by using the vibration generator.

18. The method of claim 17, wherein vibration generator produces a water vapor output from the portion of the fluid source.

19. The method of claim 17, wherein at least a portion of the vapor generator floats above a surface of the fluid source.

20. The method of claim 17, further comprising directing light emitted by a light source positioned within the vapor generator into the vapor output.

21. The method of claim 20, further comprising operating the light source with a controller, wherein the controller selects and executes from at least one program stored in a memory device, and operates the light source according to the at least one program.
